(19) United States
(12) Patent Application Publication
(10) Pub. No.: US 2019/0313626 A1
(43) Pub. Date: Oct. 17, 2019

(54) Tick Trap Belt

(71) Applicant: Jeffery Thomas Massis, Endicott, NY (US)

(72) Inventor: Jeffery Thomas Massis, Endicott, NY (US)

(21) Appl. No.: 15/952,737

(22) Filed: Apr. 13, 2018

(51) Int. Cl. A01M 23/00; A41F 9/00

(52) U.S. Cl. CPC A01M 23/005; A41F 9/002

(57) ABSTRACT

A tick trap belt for wear by an outdoorsman for stopping upward movement of ticks includes a belt having opposed ends, each end having a fastener such that the opposed ends of the belt are selectively secured about a user's body. The belt includes upper and lower edges and has opposed inner and outer surfaces extending between the upper and lower edges, respectively. The tick trap belt includes an awning or cover coupled to the upper edge of the belt and extends along the upper edge between the fasteners at the opposed ends thereof, respectively. The awning extends outwardly and downwardly away from the upper edge, the awning having a bottom surface that, in cooperation with the outer surface of the belt, defines a gap area. An adhesive member is positioned in the gap area for stopping movement of ticks who step thereon.

### BACKGROUND OF THE INVENTION

This invention relates generally to insect repelling devices and, more particularly, to a belt to be worn about the waist of an outdoorsman that traps ticks on an adhesive surface positioned in a V-shaped gap area so as to prevent ticks from lodging in the skin of the outdoorsman.

In certain parts of the country, it is common for a hunter or outdoorsman to experience a tick having crawled onto his skin and taken up residence. A tick is a small arachnid that survives by feeding on the blood of mammals. While ticks are most common lodged in the skin of dogs and similar animals, ticks also crawl their way onto a human when they have opportunity to do so and bite tightly into his skin whereby to access blood. Without making a thorough inspection of one's body after walking through a tick-rich wooded or brushy area, one or more ticks may be hosted by a person's body for hours or even days. As ticks may carry Lyme disease or other diseases, preventing ticks from reaching their desired location is of great importance.

In the past, pesticides and repellants have been used to discourage ticks from crawling onto a person. Encouraging outdoorsmen to wear long pants tucked into socks and tight rubber boots is also discouraging to ticks. Although presumably effective for their intended purposes, the existing devices and proposals have not been effective to actually immobilize and kill a tick or similar arachnid that is actively crawling upwardly on the pants or other garment of an outdoorsman.

Therefore, it would be desirable to have a tick trap belt which traps and kills ticks that are crawling on the pants of an outdoorsman. Further, it would be desirable to have a tick trap belt that is easy to attach and wear about the waist of an outdoorsman, especially when the user anticipates walking through a brushy or grassy area likely to have ticks. In addition, it would be desirable to have a tick trap belt having an awning or cover extending away from the belt that includes an adhesive strip in a gap area for the purpose of trapping ticks that crawl onto the adhesive strip.

### SUMMARY OF THE INVENTION

A tick trap belt according to the present invention for wear by an outdoorsman for stopping upward movement of ticks includes a belt having opposed ends, each end having a fastener such that the opposed ends of the belt are selectively coupled together about a user's body. The belt includes an upper edge and a lower edge opposite the upper edge and has opposed inner and outer surfaces extending between the upper edge and the lower edge, respectively. The tick trap belt includes an awning coupled to the upper edge of the belt and extends along the upper edge between the fasteners at the opposed ends thereof, respectively. The awning extends outwardly and downwardly away from the upper edge, the awning having a bottom surface that, in association with the outer surface of the belt, defines a gap area. An adhesive member is positioned in the gap area for stopping movement of ticks who step thereon.

Therefore, a general object of this invention is to provide a tick trap belt that traps ticks as they normally move upwardly along a user's clothing, such as toward the waist of a user.

Another object of this invention is to provide a tick trap belt, as aforesaid, that includes an awning or cover extending away from the belt that defines a gap area into which ticks are likely to travel and become trapped.

Still another object of this invention is to provide a tick trap belt, as aforesaid, that includes an adhesive strip positioned in the gap area onto which ticks in the gap area become stuck.

Yet another object of this invention is to provide a tick trap belt, as aforesaid, in which the awning is flexible and movable between an open configuration at which trapped ticks may be accessible and removed and a closed configuration in which the gap area is not accessible.

A further object of this invention is to provide a tick trap belt, as aforesaid, that is inexpensive to manufacture and easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a tick trap belt according to a preferred embodiment of the present invention, illustrated in an unfastened configuration;

FIG. 2 is a perspective view of the tick trap belt as in FIG. 1, illustrated in a fastened configuration and with the awning in a closed or operational configuration;

FIG. 3 is a perspective view of the tick trap belt as in FIG. 1, illustrated in a fastened configuration and with the awning in an open configuration;

FIG. 4 is a front view of the tick trap belt as in FIG. 1;

FIG. 5 is a top view of the tick trap belt as in FIG. 1;

FIG. 6a is a side view of the tick trap belt as in FIG. 3;

FIG. 6b is a sectional view taken along line 6b-6b of FIG. 6a; and

FIG. 6c is an isolated view on an enlarged scale taken from FIG. 6b.

### DESCRIPTION OF THE PREFERRED EMBODIMENT

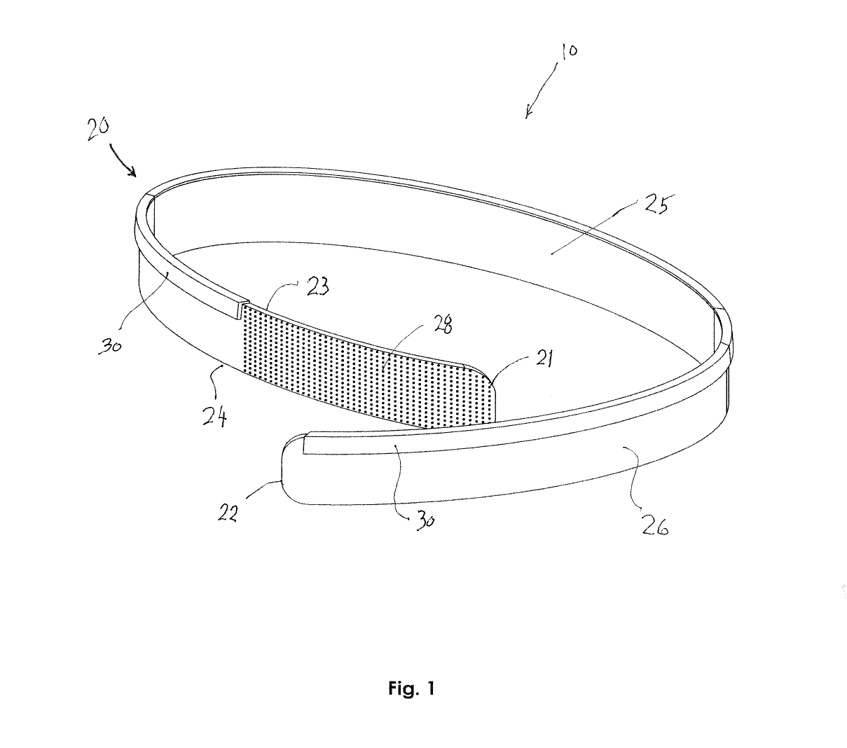

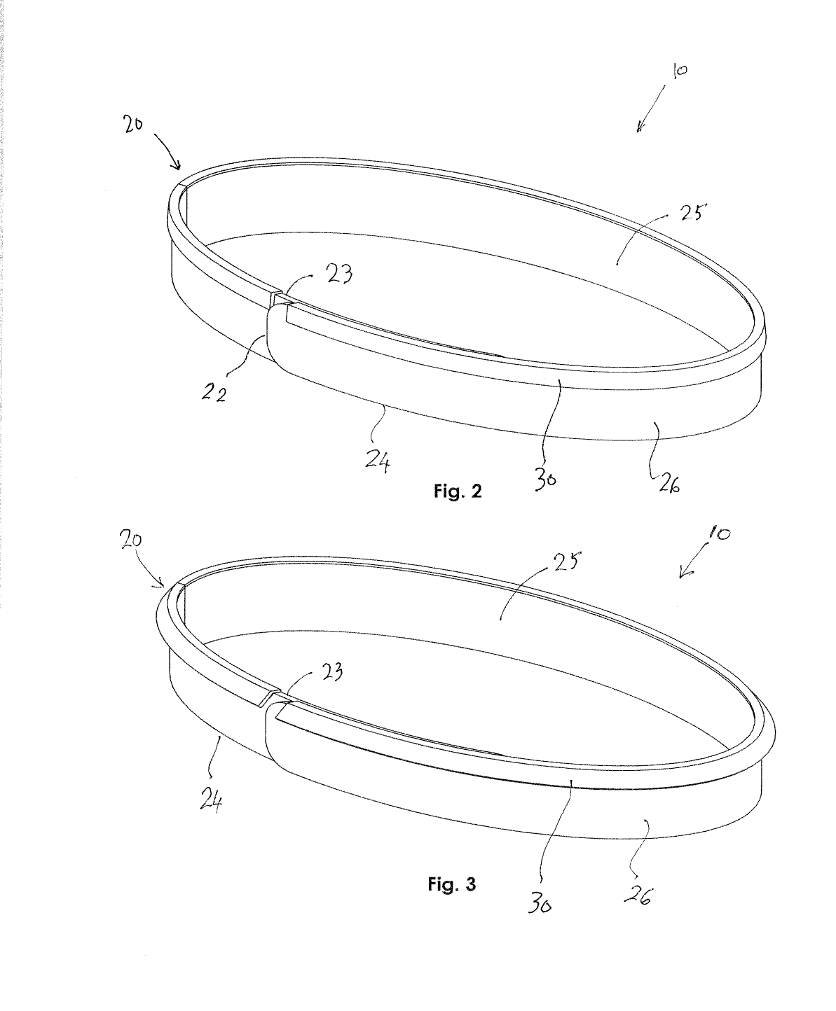

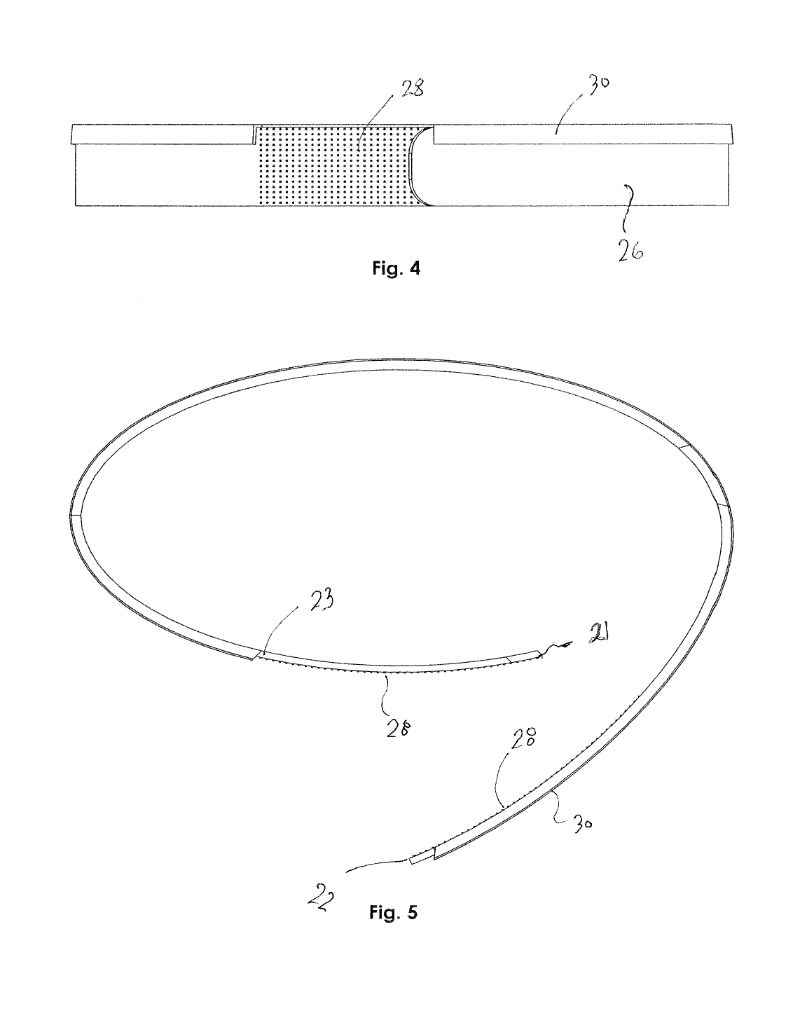

A tick trap belt according to a preferred embodiment of the present invention will now be described with reference to FIGS. 1 to 6c of the accompanying drawings. The tick trap belt 10 includes a belt 20, an awning 30 coupled to an upper edge of the belt, and an adhesive member 40 positioned in a gap area 32 of the awning 30.

The belt 20 includes a first end 21 and a second end 22 opposite the first end, the belt 20 having an elongate configuration and being constructed or nylon or a polymer fabric having characteristics similar to nylon although a belt made of leather, spandex, or the like may also work. The belt 20 includes a fastener 28 proximate the first end 21 and second end 22, i.e. the opposed ends, so that the belt 20 may be secured together about a user, preferably secured about the waist of an outdoorsman although the belt 20 may be dimensioned for use about a person's wrists, ankles, or the like. In an embodiment, the fasteners referred to herein are hook-and-loop fasteners positioned near the first and second ends, one on an inner surface and the other on the outer surface respectively (FIG. 1). However, other fasteners suitable for coupling the ends of the belt to one another may include a pin-and-holes arrangement, snaps, clasps, hooks, zippers an d the like.

More particularly, the belt 20 may include an upper edge 23 opposite a lower edge 24, the edges being generally parallel to one another except perhaps proximate the opposed ends. The belt 20 includes an inner surface 25 and an outer surface 26 having planar configurations extending between the upper and lower edges, respectively. In the manner of belts, the belt 20 according to the present invention has a generally longitudinal configuration having a length thereof. The belt 20 has a width, namely the distance between upper and lower edges. The relationship between the belt width and other components will be discussed later and is critical to the operability of the invention as a whole.

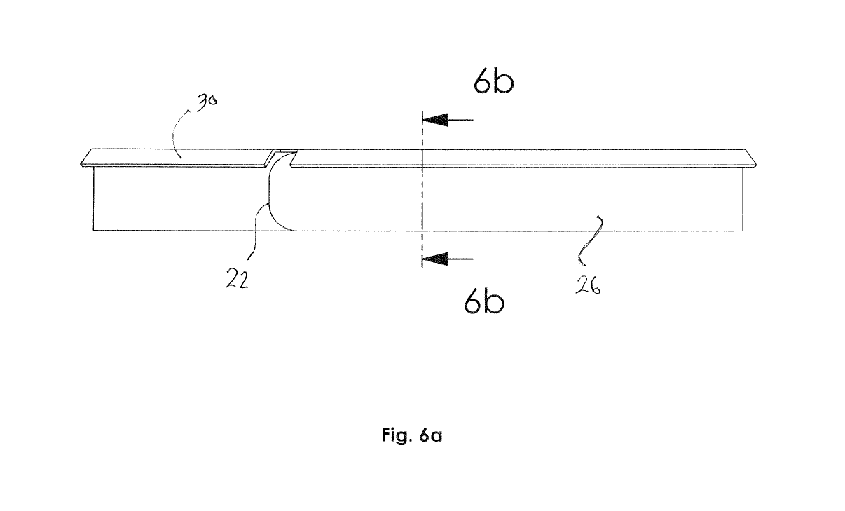

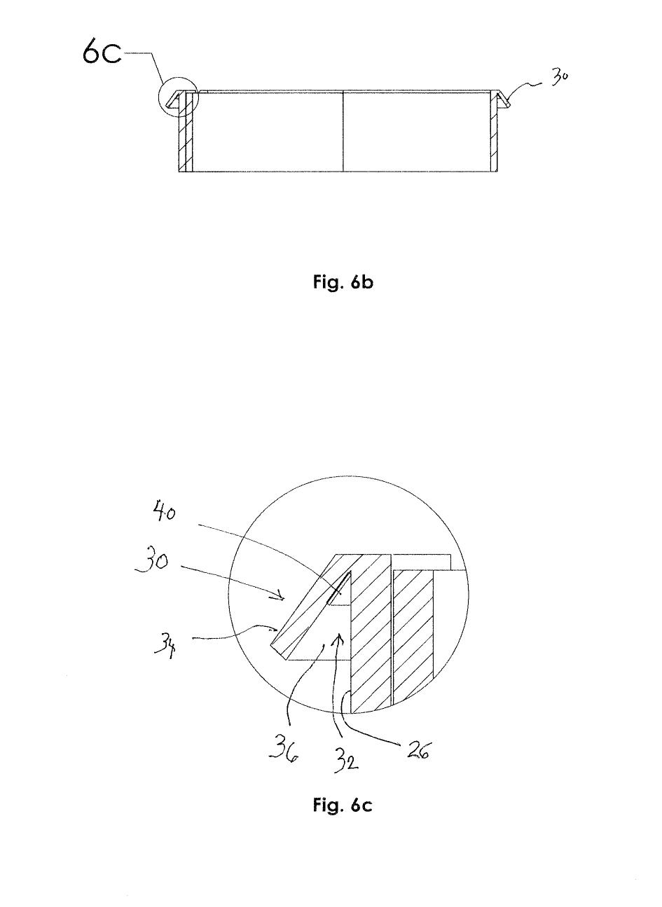

Further, the tick trap belt 10 includes an awning 30, which may also be referred to as a cover, canopy, ceiling or the like. More particularly, the awning 30 includes a generally planar surface having a flexible construction. The awning 30 includes a top surface 34 and a bottom surface 36 opposite the top surface 34. The awning 30 is preferably constructed of a flexible material similar or the same as that of the belt itself and is, therefore, flexibly movable between a closed configuration (the operational position) extending downwardly away from the upper edge 23 of the belt 20 along and adjacent to the outer surface 26 of the belt 20 (FIGS. 6a and 6b) and an open configuration extending outwardly and downwardly from the upper edge 23 of the belt (FIG. 6c). It is understood that the adhesive member 40 positioned in the gap area 32 is not easily accessible at the closed configuration but is easily accessible at the open configuration, such as for clearing the gap area 32 of dead bugs will become apparent from the discussion later.

The adhesive member 40 is positioned in the gap area 32 and has the characteristic of being sticky such that ticks or other small arachnids crawling onto the adhesive member become stuck and eventually die of starvation. The adhesive member prevents the tick from crawling beyond the belt 20 and lodging onto the skin of a person where it would otherwise suck the person's blood. Preferably, the adhesive member is positioned and coupled to a bottom surface 36 of the awning 30 proximate and adjacent to the upper edge 23 of the belt 20. Described another way, the adhesive member 40 is positioned in the apex or uppermost area of the junction between the bottom surface 36 of the awning 30 and upper end of the outer surface 26 of the belt 20 (FIG. 6b). In an embodiment, the adhesive member 40 is positioned on only one of either the bottom surface 36 of the awning 30 or on the outer surface 26 of the belt 20. In an embodiment, the adhesive member 40 may be placed on both surfaces. Together, the gap area 32 of the awning 30 and the outer surface 26 of the belt 20 may have an inverted V-shaped configuration. However, having more of a U-shaped configuration may also work. Preferably, the adhesive member 40 is made sticky by its composition of at least two forms of glue applied together on a substrate or otherwise mixed together. The adhesive member 40 may extend the entire longitudinal length of the awning 30 and may be referred to as an adhesive strip.

The dimension and configuration of the components described above are important to achieving the operability thereof. It is understood that the awning 30 has a linear and longitudinally configuration extending between the fasteners 28 of the belt 20. In addition, the awning 30 has a width dimension that is small than a width of the belt 20—the width of the belt 20 being defined as the distance between the upper edge 23 and lower edge 24 thereof. In an embodiment, the width of the awning 30 is less than 50% of a width of the belt 20. In another embodiment, the width of the awning 30 is less than 20% of the width of the belt 20. In other embodiments, the width of the awning is shorter still. Similarly, the adhesive member 40 has a width that preferably is less than 20% of a width of the awning 30.

In use, ticks or other arachnids are known to travel up a person's clothing until reaching a point where it is feasible to come into contact with a person's skin, i.e. such as near the waist of a person where clothing is loose. But in the present invention, a tick is likely to travel upwardly on the outer surface 26 of the belt 20 where it will come into contact with the bottom surface 36 of the awning 30 and become stuck in the adhesive member 40. The belt may be attached about an user's waist, wrists, ankles, or the like.

It is understood that while certain forms of this invention have been illustrated and described, it is not limited thereto except insofar as such limitations are included in the following claims and allowable functional equivalents thereof.

1. A tick trap belt for wear by an outdoorsman for stopping upward movement of ticks, comprising:
a belt strap having opposed ends, each end having a fastener such that said opposed ends of said belt are selectively coupled together about a body of the outdoorsman;
wherein said belt strap includes an upper edge and a lower edge opposite said upper edge and having opposed inner and outer surfaces extending between said upper edge and said lower edge, respectively;
an awning fixedly attached to said upper edge of said belt strap and extending along said upper edge between said fasteners at said opposed ends of said belt strap, respectively, said awning extending outwardly and downwardly away from said upper edge, said awning having a bottom surface that, in association with said outer surface of said belt strap, define a gap area;
wherein said awning and said outer surface of said belt strap together have an inverted V-shaped configuration that defines said gap area;
an adhesive member positioned in said gap area for stopping movement of ticks who step on said adhesive member, wherein said adhesive member is positioned adjacent an apex defined by said bottom surface of said awning and said outer surface of said belt strap;
wherein said adhesive member is coupled to said bottom surface of said awning and to said outer surface of said belt strap;
wherein said awning is constructed of a flexible material and is flexibly movable between a closed configuration extending downwardly from said upper edge of said belt strap adjacent said outward surface of said belt strap so that said adhesive member in said gap area is not accessible and an open configuration extending outwardly from said upper edge of said awning and displaced from said outer surface of said belt strap so that said adhesive member in said gap area is accessible;
wherein:
said belt strap is constructed of nylon;
said adhesive member includes at least two different forms of glue material on a surface of said adhesive member;
said fasteners are hook and loop fasteners.

2. (canceled)

3. (canceled)

4. (canceled)

5. (canceled)

6. (canceled)

7. The tick trap belt as in claim 1, wherein said awning defines a width that is less than 50% a width between said upper edge and said lower edge of said belt strap.

8. The tick trap belt as in claim 1, wherein said awning defines a width that is less than 20% a width between said upper edge and said lower edge of said belt strap.

9. The tick trap belt as in claim 1, wherein said adhesive member defines a width that is less than 20% a width of said awning.

10. (canceled)

11. A tick trap belt for wear by an outdoorsman for stopping upward movement of ticks, comprising:
a belt strap having a first end and a second end opposite said first end, said first and second ends each having a hook and loop fastener, respectively, such that said first end and said second of said belt strap are selectively coupled together about a user's body;
wherein said belt strap includes an upper edge and a lower edge opposite said upper edge and having opposed inner and outer surfaces extending between said upper edge and said lower edge, respectively;
an awning having a unitary construction with said upper edge of said belt strap and extending along said upper edge between said hook and loop fasteners of said first and second ends, respectively, said awning extending outwardly and downwardly from said upper edge, said awning having a bottom surface that, in cooperation with said outer surface of said belt strap, defines a gap area;
wherein said awning and said outer surface of said belt strap together have an inverted V-shaped configuration that defines said gap area
an adhesive member positioned in said gap area for stopping movement of ticks who step thereon, said adhesive member having at least two different forms of glue material on a surface of said adhesive member;
wherein said adhesive member is coupled to at said bottom surface of said awning;
wherein said awning is constructed of a flexible material and is movable by the outdoorsman between a closed configuration extending downwardly from said upper edge of said belt strap adjacent said outward surface of said belt strap so that said adhesive member in said gap area is not accessible and an open configuration extending outwardly from said upper edge of said awning and displaced from said outer surface of said belt strap so that said adhesive member in said gap area is accessible.

12. (canceled)

13. (canceled)

14. (canceled)

15. (canceled)

16. The tick trap belt as in claim 11, wherein said awning defines a width that is less than 50% a width between said upper edge and said lower edge of said belt strap.

17. The tick trap belt as in claim 16, wherein said awning defines a width that is less than 20% a width between said upper edge and said lower edge of said belt strap.

18. The tick trap belt as in claim 16, wherein said adhesive member defines a width that is less than 20% a width of said awning.

19. (canceled)
